(19) United States
(12) Patent Application Publication
(10) Pub. No.: US 2012/0303792 A1
(43) Pub. Date: Nov. 29, 2012

(54) METHOD AND APPARATUS FOR PROVIDING RECOMMENDATIONS WITHIN CONTEXT-BASED BOUNDARIES

(75) Inventor: Sailesh Kumar Sathish, Tampere (FI)

(73) Assignee: Nokia Corporation, Espoo (FI)

(21) Appl. No.: 13/115,712

(22) Filed: May 25, 2011

(51) Int. Cl. G06F 15/173

(52) U.S. Cl. 709/224

(57) ABSTRACT

An approach is provided for providing recommendations within context-based boundaries. A recommendation platform receives an input, from a device, for selecting at least one content recommendation channel, wherein the at least one content recommendation channel includes, at least in part, one or more context-based boundaries for selecting one or more content items. Next, the recommendation platform determines context information associated with the device, a user of the device, or a combination thereof. Then, the recommendation platform processes and/or facilitates a processing of the context information based, at least in part, on the at least one content recommendation channel to cause, at least in part, a selection of the one or more content items.

### BACKGROUND

Service providers and device manufacturers (e.g., wireless, cellular, etc.) are continually challenged to deliver value and convenience to consumers by, for example, providing compelling network services. One area of interest has been the use of search engine systems to provide users with links to content (e.g., websites, documents, items, songs, video, etc.). For example, a search engine may provide content to users regarding certain events. As such, the users are presented with information relevant to the events. However, the provided events may not be recommended events that are narrowly tailored for smaller geographic areas. Additionally, the events may not be narrowly tailored to recommended events that would interest users that live in a geographic region, but instead interest visitors (e.g., well-known events that visitors may not be aware of but locals are). Further, current search engine systems are inflexible such that they do not empower users to broadcast recommended content to other local users. Accordingly, service providers and device manufacturers face significant technical challenges to enabling recommendation services that are narrowly tailored to geographic regions while empowering users within the regions to more easily interact and use the services.

### SOME EXAMPLE EMBODIMENTS

Therefore, there is a need for an approach for providing recommendations within context-based boundaries.

According to one embodiment, a method comprises receiving an input, from a device, for selecting at least one content recommendation channel, wherein the at least one content recommendation channel includes, at least in part, one or more context-based boundaries for selecting one or more content items. The method also comprises determining context information associated with the device, a user of the device, or a combination thereof. The method further comprises processing and/or facilitating a processing of the context information based, at least in part, on the at least one content recommendation channel to cause, at least in part, a selection of the one or more content items.

According to another embodiment, an apparatus comprises at least one processor, and at least one memory including computer program code for one or more programs, the at least one memory and the computer program code configured to, with the at least one processor, cause, at least in part, the apparatus to receive an input, from a device, for selecting at least one content recommendation channel, wherein the at least one content recommendation channel includes, at least in part, one or more context-based boundaries for selecting one or more content items. The apparatus is also caused to determine context information associated with the device, a user of the device, or a combination thereof. The apparatus is further caused to process and/or facilitate a processing of the context information based, at least in part, on the at least one content recommendation channel to cause, at least in part, a selection of the one or more content items.

According to another embodiment, a computer-readable storage medium carries one or more sequences of one or more instructions which, when executed by one or more processors, cause, at least in part, an apparatus to receive an input, from a device, for selecting at least one content recommendation channel, wherein the at least one content recommendation channel includes, at least in part, one or more context-based boundaries for selecting one or more content items. The apparatus is also caused to determine context information associated with the device, a user of the device, or a combination thereof. The apparatus is further caused to process and/or facilitate a processing of the context information based, at least in part, on the at least one content recommendation channel to cause, at least in part, a selection of the one or more content items.

According to another embodiment, an apparatus comprises means for receiving an input, from a device, for selecting at least one content recommendation channel, wherein the at least one content recommendation channel includes, at least in part, one or more context-based boundaries for selecting one or more content items. The apparatus also comprises means for determining context information associated with the device, a user of the device, or a combination thereof. The apparatus further comprises means for processing and/or facilitating a processing of the context information based, at least in part, on the at least one content recommendation channel to cause, at least in part, a selection of the one or more content items.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing recommendations within context-based boundaries, according to one embodiment;

FIG. 2 is a diagram of the components of a recommendation platform, according to one embodiment;

FIG. 3 is a flowchart of a process for providing recommendations within context-based boundaries, according to one embodiment;

FIG. 4 is a flowchart of a process for outputting a request for receiving recommendations within context-based boundaries, according to one embodiment;

FIGS. 5A and 5B are flowcharts of processes for adding and updating content items, respectively, recommended through the recommendation platform, according to various embodiments;

FIG. 6 is a diagram of a user interface utilized in the processes of FIGS. 3 and 4, according to various embodiments;

FIG. 7 is a diagram of a user interface utilized in the processes of FIGS. 5A and 5B, according to one embodiment;

FIG. 8 is a diagram of a user interface utilized in the processes of FIGS. 3 and 4, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing recommendations within context-based boundaries are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to recommending events within context-based boundaries, it is contemplated that the approach described herein may be used for recommending any type of content within one or more context-based boundary.

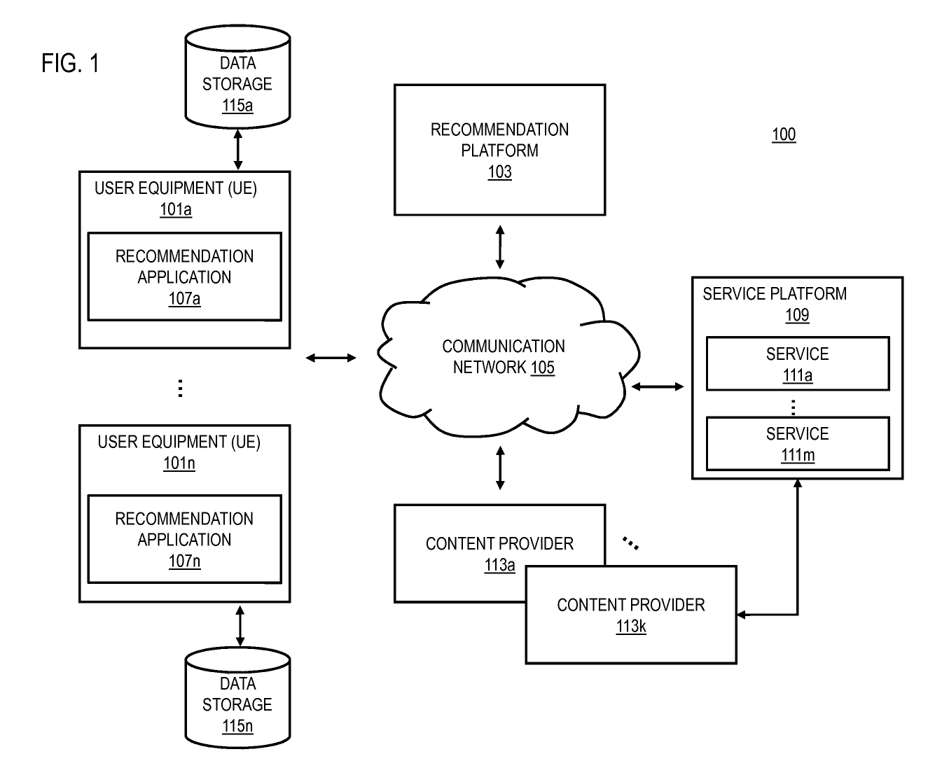

FIG. 1 is a diagram of a system capable of providing recommendations within context-based boundaries, according to one embodiment. As discussed above, search engine systems may provide users with links directed to various type of content (e.g., websites, documents, items, songs, video, events, etc.). Such systems may limit the content presented to content relevant to the search query and the selected category, thereby reducing the amount of information (e.g., links, content summaries, etc.) that the user has to review to find content of the most interest to the user. For example, a search engine may provide recommendations to users regarding certain events. However, the presented content may not be narrowly tailored for certain contexts, such as smaller geographic areas. Additionally, the recommended events may not be narrowly tailored to specific content that would interest users more familiar with the general content, such as users that are more familiar with a certain geographic region. Rather, the presented events may be more tailored to visitors to the geographic region. Further, current systems are inflexible such that they do not empower users to broadcast their own content to other local users through an easy, flexible platform.

To address this problem, a system 100 of FIG. 1 introduces the capability to provide recommendations within context-based boundaries. Specifically, the system 100 may create context-based boundaries based on, for example, the context information associated with a request for content to more narrowly tailor the presented recommended content items. By way of example, the system 100 may receive an input for selecting a recommendation channel filtered according to channel semantics and the context information. In one instance, a user selects an event channel that presents events that are occurring in the area of the user based on the user's context information. The user can provide additional data, such as the type of event that the user is interested in (e.g., garage sales), and the event channel will associate the additional data as event data and constrain the presented events according to both the additional event data and the context information of the user to present recommended content items regarding garage sales. The system 100 can handle additional contextual constraints, such as the current time of the request, to determine events that are currently active (e.g., which garage sales are open) and present a smaller subset of events to the user based on additional contextual constraints.

As shown in FIG. 1, the system 100 comprises a user equipment (UE) 101 or multiple UEs 101a-101n (or UEs 101) having connectivity to a recommendation platform 103 via a communication network 105. Running on the UEs 101 are one or more applications, including recommendation applications 107a-107n that interact with the recommendation platform 103 via the communication network 105. In communication with or contained within the UEs 101 are data storages 115-115n that store information used by the UEs 101, the recommendation applications 107a-107n, or a combination thereof. The UE 101 and the recommendation platform 103 also have connectivity to a service platform 109 hosting one or more respective services 111a-111m (also collectively referred to as services 111), and content providers 113a-113k (also collectively referred to as content providers 113). In one embodiment, the recommendation applications 107a-107n, the service platform 109, the services 111a-111m, or a combination thereof have access to, provide, deliver, etc. one or more items associated with the content providers 113a-113k. In other words, content and/or items are delivered from the content providers 113a-113k to the recommendation applications 107a-107n or the UEs 101 through the service platform 109 and/or the services 111a-111m.

In some cases, a UE 101, a service 111 and/or the content providers 113 may request that the recommendation platform 103 generate one or more recommendations with respect to content, items, functions, services, etc. to deliver to the UE 101. After receiving the request for recommendation information, the recommendation platform 103 may then retrieve the context information associated with the requesting UE 101, the service 111 and/or the content providers 113. The recommendation platform 103 may further generate a list of presented content items within one or more context-based boundaries.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the recommendation platform 103, the service platform 109 and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the recommendation platform 103 provides a platform where users can receive a presentation of recommended content items selected within context-based boundaries, the boundaries being based on the context information of the requesting device and/or user of the device. By way of example, a user desires to shop at a certain type of store but does not want to travel far to reach a store. Based on the context information of the user (e.g., the user's current location), the recommendation platform 103 provides a presentation of recommended content items that match the desired store type that are selected within a context-based geographic area that is based on the current location of the user. Thus, the user is presented with a list of stores that match the desired store type and are within an acceptable distance for the user to travel, thereby reducing the effort on the user's part to go through a list of presented items and determine if the items are within an acceptable distance.

In one embodiment, the recommendation platform 103 prioritizes the content items presented in accordance with the channel semantics (e.g., events channel, shopping channel, personal ads channel, etc.) and selected within the context-based boundaries according to parameters (e.g., context parameters) associated with the content items that relate to the context information. By way of example, a list of content items presented through a shopping channel according to shopping semantics that are within the context-based boundary still vary in, for example, their distance from the user. The recommendation platform 103 presents the list of the content items prioritized according to the closest content items to the user based on the context information presented first. By way of a further example, if the content items represent stores presented through the shopping channel that have varying store hours, the recommendation platform 103 presents the list of stores prioritized according to the closest stores with the earliest closing hours presented first, followed by the farthest stores having the earliest closing hours, followed by the closest stores having the latest closing hours, etc. Accordingly, the user is presented with a more useful list of the recommended content items.

In one embodiment, the recommendation platform 103 monitors for a change in the context information of the user, a change in the selected content items, or a combination thereof to update one or more content items presented to the user and/or update the list of selected content items presented to the user. By way of example, a content item will include information regarding when the content item expires, such as the end time of a garage sale. If, for example, the end time expires while the garage sale event is active on a list of presented content items, the recommendation platform 103 will automatically remove the specific content item from the list and/or notify the user viewing the list that the status of the content item has changed. Notification of the change in the content items presented to the user can be based on a polling notification and/or a push notification. By way of example, in one embodiment the user requests for updates in the content items. In one embodiment, the recommendation platform 103 will push update notifications regarding the change in content items. In one embodiment, the recommendation platform 103 accepts poll or push notifications based on the preferences of the user.

In one embodiment, the recommendation platform 103 also accepts group or community information related to users and/or content items. By way of example, a user can belong to a community (e.g., neighborhood association) and receive recommended content items selected based on the association of the user and the content items to the community.

In one embodiment, the presented content items are presented in the form of text, a uniform resource identifier (URIs), a uniform resource locators (URLs), or a combination thereof.

In one embodiment, the recommendation platform 103 provides a platform where users can post and update content items for presentation to other users within context-based boundaries, and associate the content items with one or more groups or communities. By way of example, a user planning on having a garage sale during the upcoming weekend can register the garage sale as a content item with the recommendation platform 103 so that other users looking to attend garage sales in the same area will be able to see the garage sale. The user can define context parameters associated with the content items to define whether to include the content item in the one or more context-based boundaries.

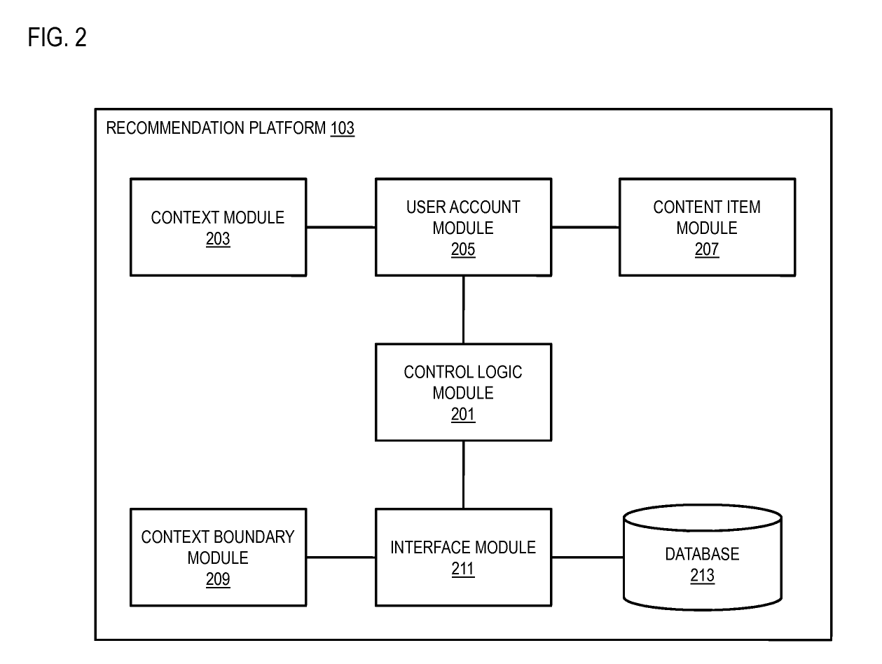

FIG. 2 is a diagram of the components of the recommendation platform 103, according to one embodiment. By way of example, the recommendation platform 103 includes one or more components for providing recommendations within context-based boundaries. It is contemplated that the functions of these components may be combined in one or more components or performed by other components of equivalent functionality. In this embodiment, the recommendation platform 103 includes a control logic module 201 that executes at least one algorithm for performing and/or coordinating the functions of the recommendation platform 103 and a database 213 for storing information used by the recommendation platform 103.

In one embodiment, the recommendation platform 103 is comprised of the control logic module 201, a context module 203, a user account module 205, a content item module 207, a context boundary module 209, an interface module 211 and a database 213.

In one embodiment, the context module 203 determines the context information from an input for selecting at least one content recommendation channel. The input may be formatted according to, for example, an extensible markup language (XML). For example, in one embodiment, the context module 203 extracts context information embedded within the input by the recommendation application 107 of the UE 101. By way of example, the context information is gathered by the recommendation application 107 from one or more other applications running on the UE 101, from one or more sensors within or in communication with the UE 101, one or more settings of the UE 101, one or more manual inputs by a user of the UE 101 operating the UE 101, one or more services 111 running on the service platform 109, one or more content providers 113, or a combination thereof. Upon gathering the context information, the recommendation application 107 embeds the context information within the request that is then input into the recommendation platform 103.

In one embodiment, the context information is not embedded in the request. Rather, upon receipt of an input for selecting at least one recommendation channel, the context module 203 of the recommendation platform 103 prompts the recommendation application 107 running on the UE 101 to gather the context information. By way of this embodiment, the amount of data sent with the input is reduced by having the context module 203 later prompt the recommendation application 107 for the context information.

In one embodiment, the context module 203 administers the type of context information required for the one or more context-based boundaries based on the subject and/or type of the input. By way of example, certain subject and/or types of inputs for recommendations merely require location information of the user of the UE 101 as the context information. In one embodiment, for these subjects and/or types of inputs, the location information is the only context information passed from the UE 101 to the recommendation platform 103. Certain other subjects and/or types of inputs for recommendations require location information and time information. In one embodiment, for these subjects and/or types of inputs, the location and time information are the only context information passed from the UE 101 to the recommendation platform 103. The context module 203 stores the relationships between the context information used to determine the context-based boundaries and the subjects and/or types of inputs. Time and location context are mentioned here as examples only and the set of context data procured can encompass different context types (such as transportation, activities, etc.).

The context information gathered by the recommendation application 107 prior to or after sending the input in response to the prompt by the context module 203 can be all or any portion of the available context information. For example, despite the context module 203 storing relationships between the context information and the subjects and/or types of inputs, more than the minimum context information that is necessary for creating a context-based boundary can be sent to the recommendation platform 103. Further, if less than the minimum information that is necessary for creating a context-based boundary for the subject and/or type of input is sent to the recommendation platform 103, the recommendation platform 103 will create a context-based boundary on whatever context information is received.

In one embodiment, the user account module 205 associates user identifications (IDs) with the various inputs into the recommendation platform 103. In one embodiment, the recommendation application 107 transmits a unique user ID with each communication to the recommendation platform 103 such that the recommendation platform 103 can track content items (e.g., events) added to the recommendation platform from the various UE 101 and the user of the UE 101.

The user account module 205 also associates each user to any one or more communities or groups registered with the recommendation platform 103 for further narrowing recommendations down to the various communities or groups. By way of example, when a user joins a group, such as the local bird watching enthusiast group, the user account module 205 associates the user's ID with the information related to the local bird watching enthusiast group (e.g., one or more context parameters) stored in the database 213.

In one embodiment, the user account module 205 validates certain information used by the recommendation platform 103. By way of example, in one embodiment, the user account module 205 validates that an input requesting to update parameters associated with a content item originates from the same user ID that initially posted the listing of the content item.

In one embodiment, the content item module 207 tracks the information related to the various content items (e.g., events) active on the recommendation platform 103. The content item module 207 indexes the information of the context items stored in the database 213 with the context parameters associated with the content items. In one embodiment, the content item module 207 also tracks the user ID for each content item registered with the recommendation platform 103 for further validation of updates to the to the content item in comparison to the information stored in the user account module 205.

In one embodiment, the context boundary module 209 determines the extent of the boundary within which recommendations of content items are made. By way of example, context information received with the input indicates that the user of the UE 101 is currently walking. Accordingly, the user is less likely to be able reach recommended content that are father away from the user. Thus, if the user requests information regarding, for example, garage sales going on in her vicinity while she is on foot, the context boundary module 209 determines that the boundary size should be small (e.g., 2 miles) because she is on foot. However, if the content information indicates that the user is traveling in a car based on, for example, sensor input indicating that the UE 101 is traveling at approximately 35 mph, the context boundary module 209 determines that the boundary size should be large (e.g., 20 miles) since the user can drive to reach farther away garage sales. In one embodiment, if the content information indicates that the user is at default location (e.g., home), the context boundary module 209 sets the boundaries to the default sizes set according to the user's preferences. In one embodiment, the input will include the size of the boundary and the context boundary module 209 will set the boundary according to the size contained in the input.

In one embodiment, the interface module 211 interfaces with one or more of the recommendation application 107 running on the UE 101, the service platform 109 and the content providers 113 to make one or more recommendations. By way of example, the interface module 211 interfaces with the recommendation application 107 to generate the various user interfaces used in interacting with the recommendation platform 103, as discussed below.

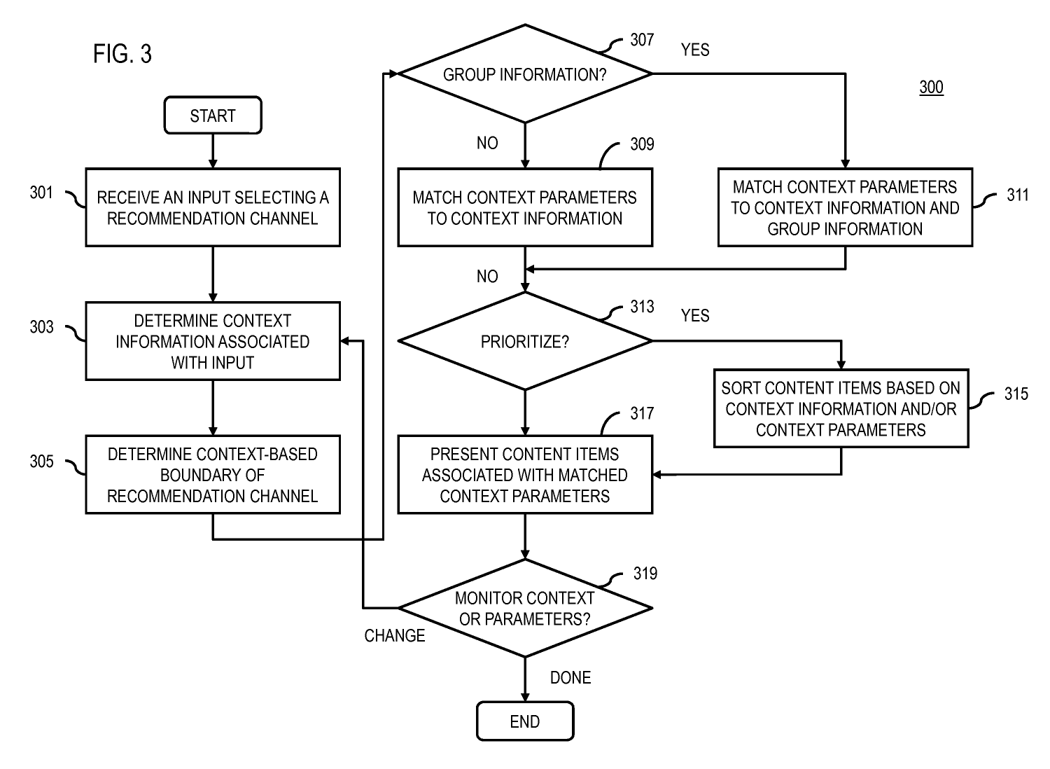

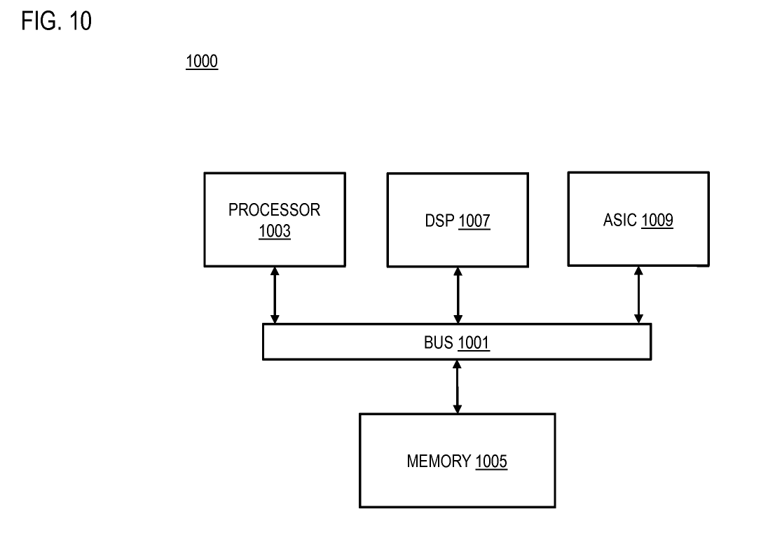

FIG. 3 is a flowchart of a process for providing recommendations within context-based boundaries, according to one embodiment. In one embodiment, the recommendation platform 103 performs the process 300 and is implemented in, for instance, a chip set including a processor and a memory as shown in FIG. 10.

In step 301, the recommendation platform 103 receives an input for selecting at least one recommendation channel. In one embodiment, the input is received from the recommendation application 107 running on the UE 101. In one embodiment, the input is received from the UE 101 from one or more hardware modules, one or more services running on the service platform 109 and one or more content providers 113, or a combination thereof.

In step 303, the recommendation platform 103 determines the context information associated with the input. As discussed above, in one embodiment, the context information associated with the input is embedded in the input. The recommendation platform 103 analyzes the input for one or more, for example, headers or tags that indicate the presence of the context information. In one embodiment, the context information is not embedded in the input to the recommendation platform 103. In response to receiving the input at step 303, the recommendation platform 103 prompts the device from which the input was sent (e.g., the UE 101) for the context information of the device, the user of the device, or a combination thereof.

In step 305, the recommendation platform 103 determines the context-based boundary for the recommendation channel. In one embodiment, the context-based boundary is based on information contained in the input. For example, the input includes headers or tags that indicate the desired context-based boundary according to preferences set by the device or the user of the device. In one embodiment, the context-based boundary is based on a default value set according to received context information. For example, if the context information indicates that the input was sent from a device when the device was at a default location (e.g., home), the context-based boundary is set according to the default setting for the default location. In one embodiment, the context-based boundary is based on the context information in a more dynamic way such as, for example, based on a speed context information, as discussed above.

In step 307, the recommendation platform 103 determines if the device and/or the user of the device from which the input was sent is associated with a group or community. In one embodiment, the recommendation platform 103 determines the group information based on an association of the user ID embedded within the input with a user ID stored within the database 213 of the recommendation platform 103. In one embodiment, the recommendation platform 103 determines the group information based on, for example, headers or tags within the input that directly indicate the group information associated with the device and/or the user of the device. If the input is associated with group or community information, the process proceeds to step 311. If the input is not associated with group or community information, the process proceeds to step 309.

In step 309, the recommendation platform 103 processes the context information to determine if the context information substantially matches context parameters associated with one or more content items. In one embodiment, the recommendation platform 103 runs one or more algorithms to determine if the context information substantially matches all, any or a minimum of the context parameters for the content items. The content items that have context parameters that substantially match the content information are further analyzed by the recommendation platform 103 to determine if their parameters match any one of the subject and/or type of the input based on one or more algorithms to further narrow the content items selected by the recommendation platform 103 to present to the user.

In step 311, the recommendation platform 103 performs essentially the same process as in step 309 with the addition of analyzing the group or community information associated with the request. In one embodiment, where context information of the input does not associate the input with certain content items associated with a community, the recommendation platform 103 at step 311 associates the input with the community and further filters the content items based on the subject and/or type of the input. Thus, the user can receive recommendations based on communities that the user belongs to and finds of interest without necessarily having context information that matches the same content items.

In step 313, after selecting one or more content items for presentation to the device from which the input was received, the recommendation platform 103 determines whether the input requested prioritization of the content items in their presentation. If the input requested that the contents items are prioritized, the process 300 proceeds to step 315. If the input did not request that the contents items are prioritized, the process 300 proceeds to step 317. In one embodiment, the request to prioritize the selected content items can be, for example, embedded in the input. In one embodiment, the request to prioritize the selected content items can be, for example, associated with the user ID associated with the input and stored in the database 213.

In step 315, the recommendation platform 103 prioritizes the selected content items based on, for example, the context parameters associated with the content items. In one embodiment, the content items are prioritized according to a location context parameter, with the content items having the closest location context parameters prioritized over content items having the farthest location context parameters within the location-based boundary. In one embodiment, the content items are prioritized according to a time context parameter, with the content items having the soonest occurring time context parameters prioritized over content items having the latest occurring time context parameters within the time-based boundary.

In step 317, the recommendation platform 103 presents the prioritized or un-prioritized selected content items to the device from which the input was received. In one embodiment, the recommendation platform presents links (e.g., URLs or URIs) to the device from which the input was received to present the context items. The links can direct the user to additional information from one or more services 111 running on the service platform 109 or one or more content providers 113. The user of the device can then select one or more of the links and be directed to additional information or the specific information regarding the content item. By way of example, one of the content items is associated with a garage sale occurring in the neighborhood. The garage sale is associated with a website on the Internet. The link associated with the garage sale directs the user to the associated website upon selecting the link.

In step 319, the recommendation platform 103 monitors for a change in the context information associated with the device or the user of the device from which the input was received and/or a change in the context parameters associated with the context items selected for presentation to the device. In one embodiment, the recommendation platform 103 actively monitors for a change in the context information by continuously prompting for the context information from the device that sent the input. In one embodiment, the recommendation platform 103 passively monitors for a change in the context information by waiting for an additional input from the device that indicates a change in the context information has occurred. If a change is detected while the presentation of the selected content items is active, or for a period of time after presentation of the selected content items, the process 300 restarts at step 303 and determines the content information associated with the input. If no change is detected while the process 300 is active, the process 300 ends. In one embodiment, if the process 300 remains active, content items that are newly selected or de-selected according to a rerunning of the process 300 are presented to the UE 103 in a push-style notification to let the user more easily identify a change in the content items. In one embodiment, the content items are newly selected or de-selected based on a change in the context information, a change in the context parameters associated with content items, or a combination thereof. In one embodiment, the process 300 can remain active by either by having an active presentation of the selected content items on the device executing the process 300 or by the process 300 remaining active in the memory of the device executing the process 300.

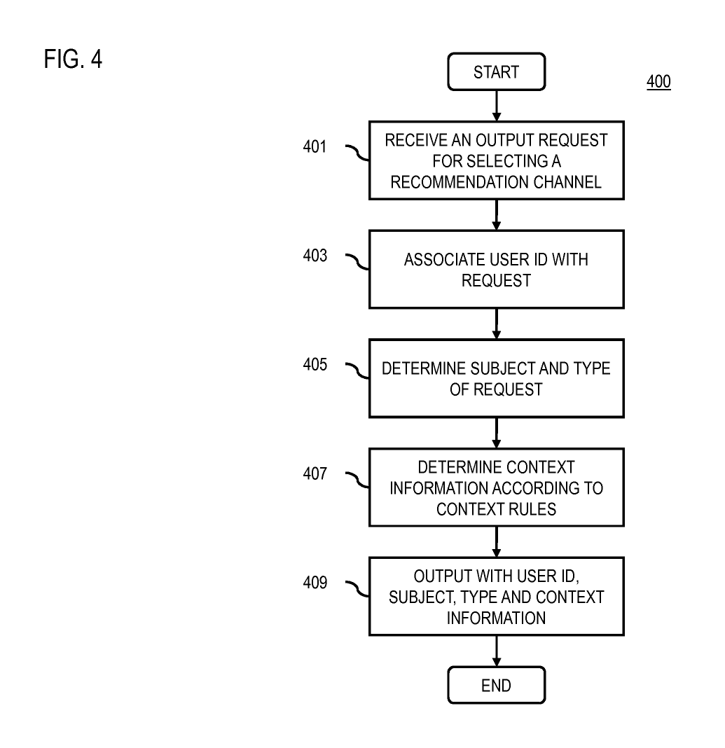

FIG. 4 is a flowchart of a process for outputting a request for receiving recommendations within context-based boundaries, according to one embodiment. In one embodiment, the recommendation application 107 performs the process 400. Alternatively, the process 400 can be, for instance, implemented by a chip set including a processor and a memory as shown in FIG. 10, by one or more modules on the UE 101 or by one or more services 111 implemented by the service platform 109.

In step 401, the recommendation application 107 receives an output request for selecting a recommendation channel to receive recommended content items within context-based boundaries. In one embodiment, a user of the UE 101 enters a request through the interface of the UE 101.

In step 403, the recommendation application 107 associates a user ID associated with the user of the UE 101 with the output request. By way of example, the recommendation application 107 reads a user ID stored in data storage 115 within or in communication with the UE 101 to obtain the user ID. By way of example, the user of the UE 101 may enter the user ID each time the user interfaces with the UE 101 to make an output request. In one embodiment, any groups or communities that are associated with the user ID are also determined at step 403 and are included in the output request.

In step 405, the recommendation application 107 determines the subject and/or the type of the request. For example, the request could be for all events relating to sports within a given context-based boundary. The type of the request would be ‘events’ and the subject of the request would be ‘sports.’ In one embodiment, the recommendation application 107 prompts the user of the UE 101 for the subject and type of the request. In one embodiment, the recommendation application 107 analyzes the output request with one or more algorithms to determine the subject and type of the request.

In step 407, the recommendation application 107 determines the context information of the UE 101, the user of the UE 101, or a combination thereof. In one embodiment, the recommendation application 107 determines all of the context information that exists at the time of receiving the output request. In one embodiment, the recommendation application 107 determines the context information of the UE 101, the user of the UE 101, or a combination thereof based on context rules sent from the recommendation platform 103 associated with the subject and/or type of the output request. By way of example, if the output request is for sporting events, a context rule for ‘events’ and ‘sports’ would include context information regarding the location of the UE 101, the user of the UE 110, or a combination thereof and a current or future date and/or time. In one embodiment, if the recommendation application 107 cannot determine the entire context information associated with a context rule, the recommendation application 107 leaves the unknown context information blank or inserts default context information. For example, if a context rule asks for time information, but the time information is not currently available, the recommendation application inserts a default value for time information (e.g., 12 hours, 24 hours, 12:00, etc.).

The context information for step 407 is collected from one or more sensors within or in communication with the UE 101, one or more applications running on the UE 101, one or more services 111 running on the service platform 109, and/or one or more content providers 113. The context information can include, for example, the location of the UE 101 or the user of the UE 101, the current time or a future time, a current activity of the UE 101 or the user of the UE 101, a mode-of-transport of the UE 101 or the user of the UE 101, or a combination thereof. By way of example, a navigation application running on the UE 101 with an active route guidance to a location indicates a current activity of the UE 101 and a current mode-of-transport of the UE 101, which constitute, in part, the context information of the UE 101.

In one embodiment, the context rules that define the context parameters that are associated with each subject and/or type of input are set by the recommendation platform 103 and the recommendation application 107. In one embodiment, every communication between the recommendation platform 103 and the recommendation application 107 updates the recommendation platform 103 of the updated context rules, where the recommendation application 107 sets the context rules. In one embodiment, every communication between the recommendation platform 103 and the recommendation application 107 updates the recommendation application 107 of the updated context rules, where the recommendation platform 103 sets the context rules.

In step 409, the recommendation application 107 outputs the output request to, for example, the recommendation platform 103. The output includes the determined user ID, any groups or communities that the user belongs to, the subject and type of the request, and the context information associated with the UE 101, the user of the UE 101, or the combination thereof. The request can be sent in any type of machine-readable format, such as, for example, extensible markup language (XML).

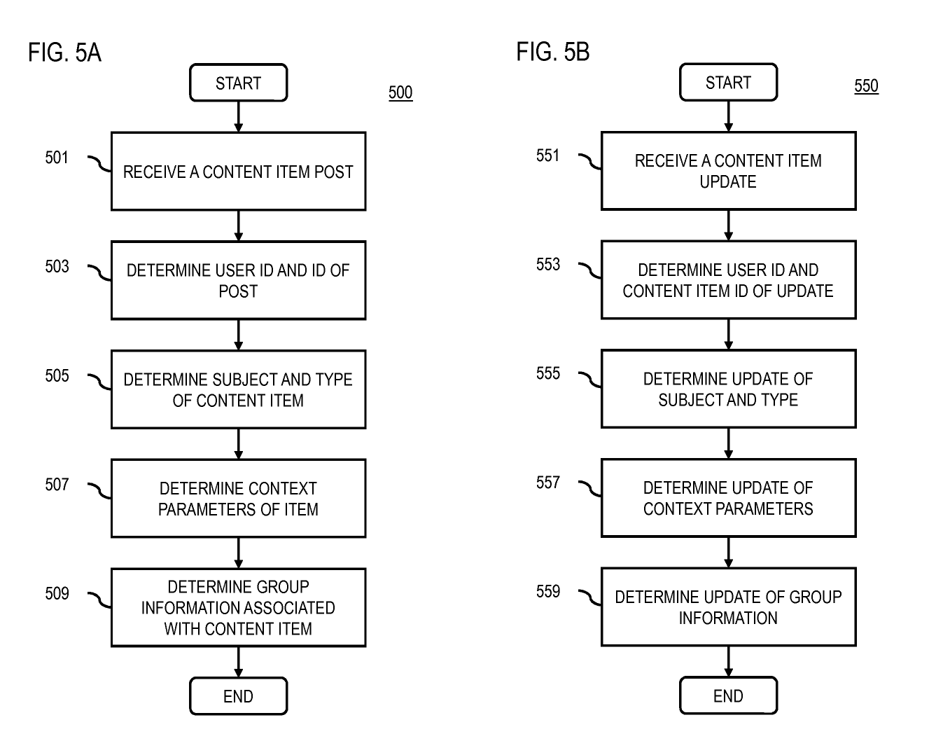

FIG. 5A and 5B are flowcharts of processes for registering and updating content items, respectively, recommended through the recommendation platform 103, according to one embodiment. In one embodiment, the recommendation platform 103 performs the processes 500 and 550. Alternatively, the processes 500 and 550 can be, for instance, implemented by a chip set including a processor and a memory as shown in FIG. 10, by one or more modules on the UE 101 or by one or more services 111 implemented by the service platform 109.

In step 501 of the process 500, the recommendation platform 103 receives an input to register a content item to the recommendation platform 103. The input can be formatted, for example, according to extensible markup language (XML) or according to the hypertext transfer protocol (HTTP). The input request will include, for example, a title field for the content item, a short description field for the item, and a long description field for the item. The input request may also contain a link for additional information for the content item, that points to, for example, one or more services 111 running on the service platform 109 or one or more content providers 113.

In step 503 of the process 500, the recommendation platform 103 determines the user ID of the input. By way of example, the input will include tags or headers that include the user ID. In one embodiment, the recommendation platform 103 prompts the device from which the input was received for the user ID if the user ID is not included within the input. With the user ID, the recommendation platform 103 associates the input request and subsequent content item with a specific user. In step 503, the recommendation platform 103 also issues a content item ID to new content items.

In step 505 of the process 500, the recommendation platform 103 determines the subject and type of the content item. In one embodiment, the input will include one or more headers or tags that indicate the subject and/or type of the content item. In one embodiment, the recommendation platform 103 uses one or more algorithms to parse and analyze the information contained in, for example, the title, short description, and long description fields of the input to determine the subject and/or type. In one embodiment, the subject and/or type are contained in the one or more headers or tags within the input and are compared to the subject and/or type information retrieved from the title, short description and long description fields of the input to validate the subject and/or type of the content item.

In one embodiment, the recommendation platform 103 can determine one of the subject and the type of the content item from the other of the subject and type of the content item using one or more algorithms. Additionally, if the subject and/or type of the content item as listed in the input is narrow, the recommendation platform 103 can broaden the subject and/or type of the content item using one or more algorithms. By way of example, if the subject of a content item is ‘garage sales’ the recommendation platform determines that the subject is ‘shopping’ and the type of content item is ‘event.’

In step 507 of the process 500, the recommendation platform 103 determines the context parameters associated with the input. The context parameters can be embedded in the input in one or more headers or tags. In one embodiment, the input can contain as many context parameters as requested. In one embodiment, the recommendation platform 103 validates the input and content item by comparing the type of context parameters contained in the input to context rules stored in the database 213 of the recommendation platform 103 to determine whether the type of context parameters included in the input match the context parameters listed in the context rules for the given subject and/or type of the content item.

In step 509 of the process 500, the recommendation platform 103 determines whether there is any information contained in the input regarding group or community information. By way of example, the content item may be a listing of a garage sale taking place in a gated neighborhood community. The content item may include a reference to the specific gated neighborhood community for other members of the gated neighborhood community. After step 509, the recommendation platform 103 indicates to the device from which the input originated that the input request was successful. By way of example, the recommendation platform 103 sends a 200 OK HTTP response. Then, the process 500 ends.

The process of 550 in FIG. 5B is similar to the process 500 in FIG. 5A except that the process 5B is for updating the information of content items already registered with the recommendation platform 103.

In step 551 of the process 550, the recommendation platform 103 receives an input to update the information of a content item registered with the recommendation platform 103. The input can be formatted, for example, according to extensible markup language (XML) or according to the hypertext transfer protocol (HTTP), as discussed above. In one embodiment, the update input can be, for example, the same as a register request, as discussed above, with the same information except the input includes the desired updates. In one embodiment, the input update will include only the updated information such that any information that is not contained in the input will not be altered. The input may include, for example, updates to the title field for the content item, updates to the short description field for the item, and updates to the long description field for the item. The input may also contain a new link for additional information for the content item, that points to, for example, one or more services 111 running on the service platform 109 or one or more content providers 113.

In step 553 of the process 550, the recommendation platform 103 determines the user ID of the input and the content item ID of the input and verifies that the user ID has authority to modify the existing content item of the same content item ID. In one embodiment, the authorization can be done by matching similar user IDs. In one embodiment, the authorization can also include one or more identification challenges, such as passwords or pin numbers. By way of example, the input will include tags or headers that include the user ID and the content item ID. In one embodiment, the recommendation platform 103 prompts the device from which the input was received for the user ID and the content item ID if the information was not included within the input.

In step 555 of the process 550, the recommendation platform 103 determines changes, if any, to the subject and type of the content item. In one embodiment, the input will include one or more headers or tags that indicate the updated subject and/or type of the content item. In one embodiment, the recommendation platform 103 uses one or more algorithms to parse and analyze the information contained in, for example, the updated title, short description, and long description fields of the update input. In one embodiment, the subject and/or title information contained in the one or more headers or tags within the update input are compared to the subject and/or type information retrieved from the updated title, short description and long description fields of the input to validate the updated subject and/or type of the content item.

In step 557 of the process 550, the recommendation platform 103 determines updates to the context parameters associated with the input. The updated context parameters can be embedded in the input in one or more headers or tags. In one embodiment, the input can contain as many updated context parameters as requested. In one embodiment, the recommendation platform 103 validates the update input and the content item by comparing the type of context parameters contained in the update input to the context rules stored in the database 213 of the recommendation platform 103 to determine whether the type of updated context parameters included in the input match the context parameters listed in the context rules for the given subject and/or type of the content item.

In step 559 of the process 550, the recommendation platform 103 determines whether there is any information contained in the input regarding updated group or community information. After step 509, the recommendation platform 103 indicates to the device from which the update input originated that the update input request was successful. By way of example, the recommendation platform 103 sends a 200 OK HTTP response. Then, the process 550 ends.

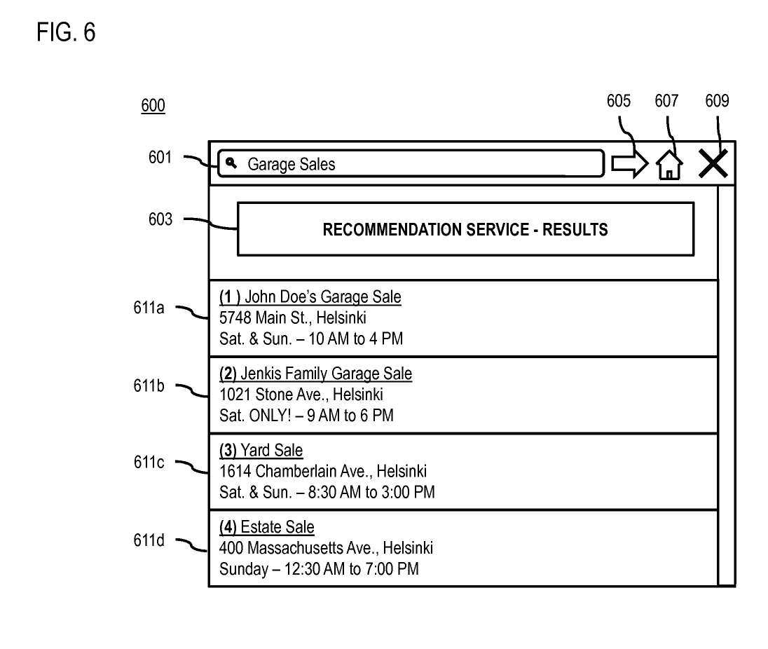

FIG. 6 is a diagram of a user interface utilized in the processes of FIGS. 3 and 4, according to various embodiments. The user interface 600 can be of, for example, a UE 101 running a recommendation application 107 that is interacting with the recommendation platform 103. In one embodiment, the user interface 600 includes indicator 601 that is a query box that allows a user to enter the subject and/or type of the input for receiving recommended content items within a context-based boundary. In one embodiment, the indicator 601 is divided into two smaller indicators and displayed as drop down boxes that list default subjects and types. Indicators 605, 607 and 609 are indicators for activating the recommendation process, returning to the home screen of the recommendation process (e.g., FIG. 6 without indicators 603 and 611a-d) and exiting the recommendation service, respectively. Indicator 603 illustrates the title bar for a user interface 600 after receiving selections of recommended content items within a context-based boundary. Prior to activating the search, indicators 603 and 611a-d are not present; the user interface is instead blank. Indicators 611a-d illustrate the content items recommended by the recommendation platform 103 in response to receiving the input of ‘Garage Sales.’ The content items are all within the context-based boundary of, for example, the city of Helsinki

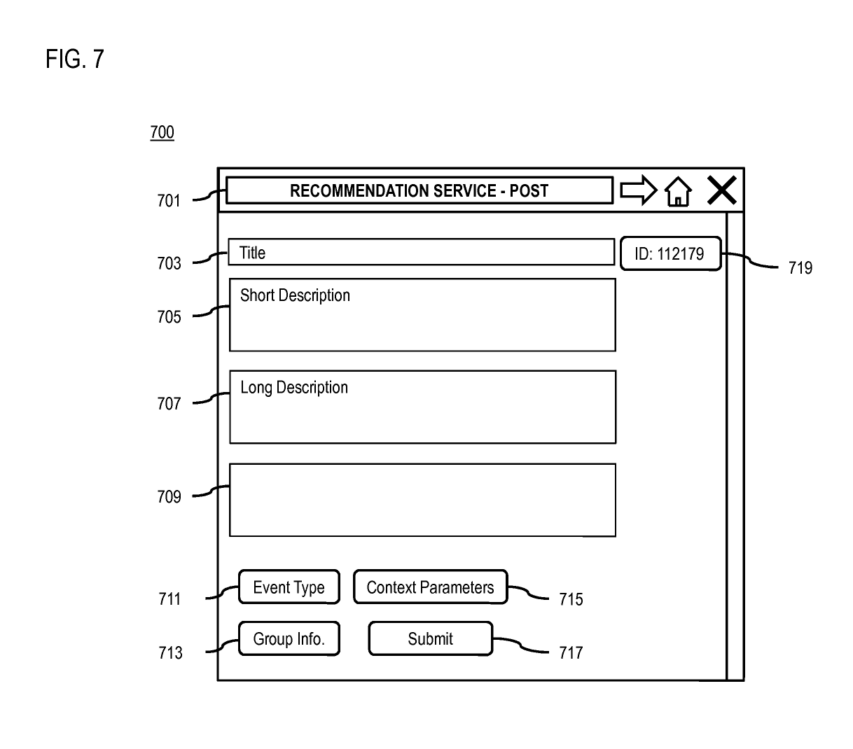

FIG. 7 is a diagram of a user interface utilized in the processes of FIGS. 5A and 5B, according to one embodiment. The user interface 700 can be of, for example, a UE 101 running a recommendation application 107 that is interacting with the recommendation platform 103. In one embodiment, the user interface 700 includes indicator 701 that illustrates that a user of the UE 101 running the recommendation application 107 is registering or updating a content item with the recommendation platform 103 through a ‘POST’ input. Indicators 703, 705 and 707 illustrate boxes for the user to describe or update the description of the content item through a title, a short description and a long description, respectively. Indicators 711, 713 and 715 illustrate buttons that, once activated, allow the user to describe or update the description of the event type, group information and context parameters associated with the content item, respectively, in the indicator 709 field. Indicator 717 allows the user to submit the content item post or update once the user is finished entering the information. In one embodiment, in the event that the user interface 700 is of an update, the interface also includes indicator 719 that illustrates the specific content item ID that is being updated at the recommendation platform 103. In one embodiment, in the event that the user interface 700 is of an posting a content item, the interface also includes indicator 719 that illustrates the specific content item ID that the content item will have upon being registered at the recommendation platform 103.

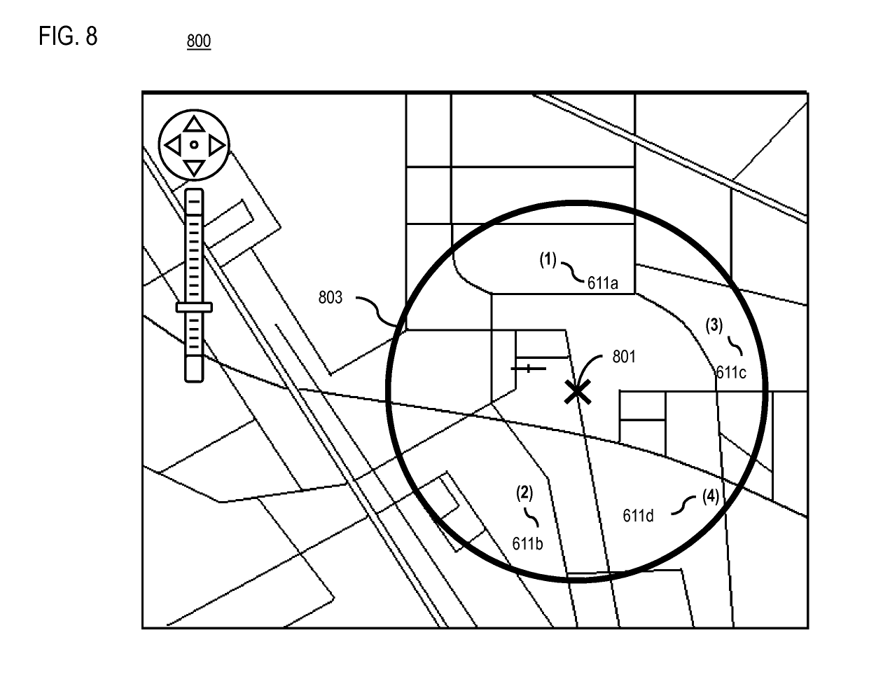

FIG. 8 is a diagram of a user interface utilized in the processes of FIGS. 3 and 4, according to one embodiment. The user interface 800 can be of, for example, a UE 101 running a recommendation application 107 that is interacting with the recommendation platform 103. In one embodiment, the user interface 800 allows the user to manually enter context information of, for example, the user's current location. Indicator 801 illustrates the position of the user marked manually by the user on a map illustrating the local surroundings of the user. Indicator 803 indicates the extent of the context-based boundary from within which content items are recommended. Indicators 611a-d indicate the content items displayed according to their locations across the map giving the user an idea of where the content items are with respect to the user's location.

The processes described herein for providing recommendations within context-based boundaries may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

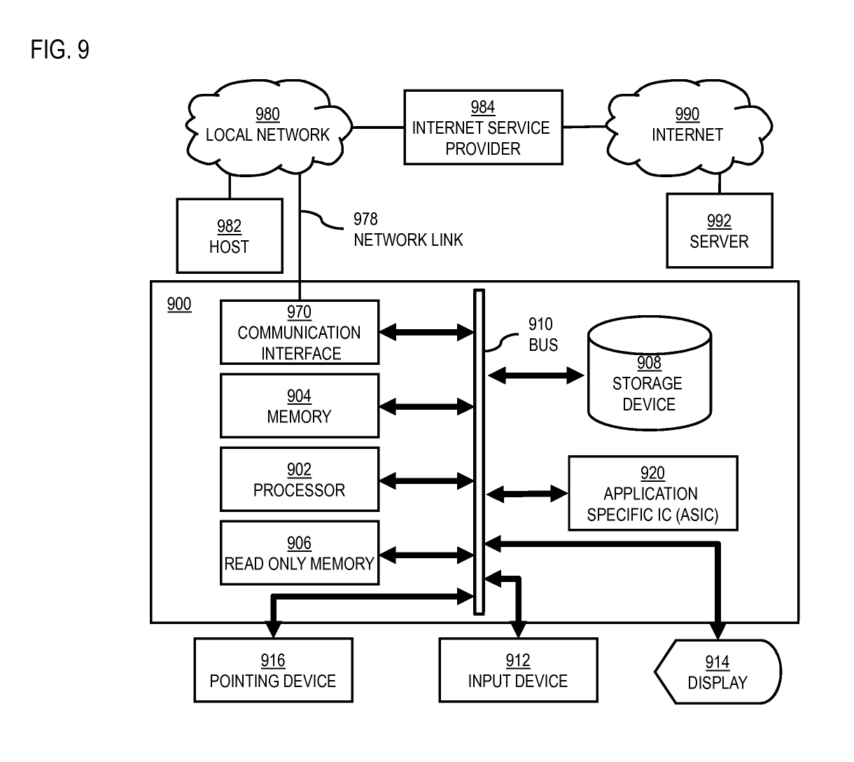

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide recommendations within context-based boundaries as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing recommendations within context-based boundaries.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing recommendations within context-based boundaries. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing recommendations within context-based boundaries. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing recommendations within context-based boundaries, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing recommendations within context-based boundaries to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide recommendations within context-based boundaries as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing recommendations within context-based boundaries.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to providing recommendations within context-based boundaries. The memory 1005 also stores the data associated with or generated by the execution of the inventive steps.

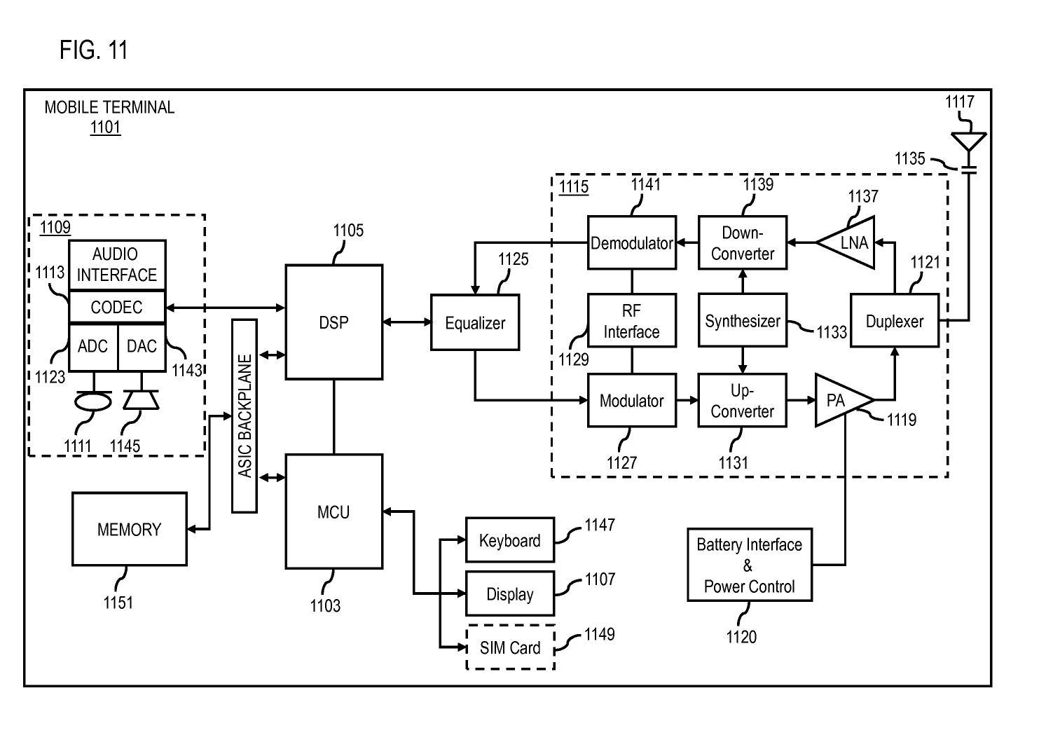

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing recommendations within context-based boundaries. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing recommendations within context-based boundaries. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide recommendations within context-based boundaries. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
an input, from a device, for selecting at least one content recommendation channel, wherein the at least one content recommendation channel includes, at least in part, one or more context-based boundaries for selecting one or more content items;
context information associated with the device, a user of the device, or a combination thereof; and
a processing of the context information based, at least in part, on the at least one content recommendation channel to cause, at least in part, a selection of the one or more content items.

2. A method of claim 1, wherein the (1) data and/or (2) information and/or (3) at least one signal are further based, at least in part, on the following:
an association of one or more context parameters with the one or more content items.

3. A method of claim 2, wherein the processing of the context information comprises, at least in part, determining that the context information substantially matches at least one of the one or more context parameters.

4. A method of claim 2, wherein the (1) data and/or (2) information and/or (3) at least one signal are further based, at least in part, on the following:
another input for specifying at least one of the one or more content items, the one or more context parameters associated with the at least one of the one or more content items, or a combination thereof.

5. A method of claim 2, wherein the (1) data and/or (2) information and/or (3) at least one signal are further based, at least in part, on the following:
at least one sort priority for the one or more content items based, at least in part, on the one or more context parameters,
wherein a presentation of the one or more content items is based, at least in part, on the at least one sort priority.

6. A method of claim 1, wherein the (1) data and/or (2) information and/or (3) at least one signal are further based, at least in part, on the following:
at least one group associated with the device, the user of the device, or a combination thereof,
wherein the selection of the one or more content items is further based, at least in part, on the at least one group.

7. A method of claim 2, wherein the (1) data and/or (2) information and/or (3) at least one signal are further based, at least in part, on the following:
a monitoring of the context information, the one or more context parameters, or a combination thereof; and
an update of the selection of the one or more content items based, at least in part, on the monitoring.

8. A method of claim 1, wherein the context information is provided by one or more sensors associated with the device, by manual input from the device or the user of the device, or a combination thereof.

9. A method of claim 1, wherein the (1) data and/or (2) information and/or (3) at least one signal are further based, at least in part, on the following:
a determination of the context-based boundaries based, at least in part, on the context information.

10. A method of claim 2, wherein the one or more content items include, at least in part, one or more events, and wherein the one or more context parameters include, at least in part, a location parameter, a time parameter, an activity parameter, a mode-of-transport parameter, or a combination thereof.

11. An apparatus comprising:
at least one processor; and
at least one memory including computer program code for one or more programs,
the at least one memory and the computer program code configured to, with the at least one processor, cause the apparatus to perform at least the following,
receive an input, from a device, for selecting at least one content recommendation channel, wherein the at least one content recommendation channel includes, at least in part, one or more context-based boundaries for selecting one or more content items;
determine context information associated with the device, a user of the device, or a combination thereof; and
process and/or facilitate a processing of the context information based, at least in part, on the at least one content recommendation channel to cause, at least in part, a selection of the one or more content items.

12. An apparatus of claim 11, wherein the apparatus is further caused to:
cause, at least in part, an association of one or more context parameters with the one or more content items.

13. An apparatus of claim 12, wherein the processing of the context information comprises, at least in part, determining that the context information substantially matches at least one of the one or more context parameters.

14. An apparatus of claim 12, wherein the apparatus is further caused to:
receive another input for specifying at least one of the one or more content items, the one or more context parameters associated with the at least one of the one or more content items, or a combination thereof.

15. An apparatus of claim 12, wherein the apparatus is further caused to:
determine at least one sort priority for the one or more content items based, at least in part, on the one or more context parameters,
wherein a presentation of the one or more content items is based, at least in part, on the at least one sort priority.

16. An apparatus of claim 11, wherein the apparatus is further caused to:
determine at least one group associated with the device, the user of the device, or a combination thereof,
wherein the selection of the one or more content items is further based, at least in part, on the at least one group.

17. An apparatus of claim 12, wherein the apparatus is further caused to:
cause, at least in part, a monitoring of the context information, the one or more context parameters, or a combination thereof; and
determine to update the selection of the one or more content items based, at least in part, on the monitoring.

18. An apparatus of claim 11, wherein the context information is provided by one or more sensors associated with the device, by manual input from the device or the user of the device, or a combination thereof.

19. An apparatus of claim 11, wherein the apparatus is further caused to:
determine the context-based boundaries based, at least in part, on the context information.

20. An apparatus of claim 12, wherein the one or more content items include, at least in part, one or more events, and wherein the one or more context parameters include, at least in part, a location parameter, a time parameter, an activity parameter, a mode-of-transport parameter, or a combination thereof.

21-48. (canceled)
